(19) United States
(12) Patent Application Publication
(10) Pub. No.: US 2007/0280685 A1
(43) Pub. Date: Dec. 6, 2007

(54) Method of Optimising Connection Set-Up Times Between Nodes in a Centrally Controlled Network

(76) Inventors: Miguel De Vega Rodrigo, Woluwe St. Lambert Brussels (BE); Robert Pleich, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/594,476

(22) PCT Filed: Feb. 4, 2005
(86) PCT No.: PCT/EP05/01405

§ 371 Date: Jul. 17, 2007

(30) Foreign Application Priority Data
Mar. 31, 2004 (GB) 0407154.4

(51) Int. Cl. H04Q 11/00; H04J 14/00; H04L 12/56

(52) U.S. Cl. 398/45; 370/254

(57) ABSTRACT

In one aspect, a method of optimizing connection set-up times between nodes in a centrally controlled network comprises sending a path set-up request from a node to a controller is provided If a connection cannot be made at a requested time, not sending a no acknowledgment message, but only and sending an acknowledgment message from the controller to the node when the network connection has been established.

This invention relates to a method of optimising connection set-up times between nodes in a centrally controlled network, in particular for optical networks. A problem in centralized optical networks is how to optimize the path setup and teardown process in centralized optical networks. Generally, signalling in centralized optical networks is done via one or several control entities which are in charge of coordinating the rest of the network elements. This type of architecture is popular, since it has many advantages including fast connection setup and teardown, highly controllable and predictable network behaviour, call admission control (CAC), billing and charging, routing, security, congestion control, congestion avoidance and load balancing algorithms are easy to implement. In addition it reduces the signalling requirement over other decentralised systems, avoiding problems derived from a poor timing of the signalling messages, since the scheme is topology independent and allows a reduction in the complexity in the network nodes (edge nodes and optical switches), since most of the signalling processing is done at the control entity. Another benefit is that it is relatively easy to make software or hardware upgrades in the control plane, since in most cases only the control entity will have to be modified. For these reasons, users wish to maintain this type of architecture, but there is always pressure to improve performance.

In accordance with the present invention, a method of optimising connection set-up times between nodes in a centrally controlled network comprises sending a path set-up request from a node to a controller; if a connection cannot be made at a requested time, not sending a no acknowledgement message, but only sending an acknowledgment message from the controller to the node, when the network connection has been established.

By cutting out the conventional no acknowledgement message indicating that a connection cannot be made at the requested time, it is not necessary for the node to resend its request to the controller an open ended number of times. It must simply wait until the resources are available and then it is notified.

Preferably, the node implements a queuing scheme whilst waiting for the acknowledgement, such that IP packets received at the node whilst awaiting a connection are discarded in accordance with the queuing scheme.

Different types of queuing scheme are possible, but preferably the queuing scheme comprises one of first in first out (FIFO), last in first out (LIFO), or weighted fair queuing (WFQ).

For a WFQ scheme, preferably the scheme selectively dismisses internet protocol (IP) packets having a lower priority in order to store more recently arrived IP packets having a higher priority.

As each IP packet reaches a node awaiting a connection, they are assessed for priority and ordered accordingly, so that at any time the packets, whether old or new, having the highest priority are saved and the lowest priority ones are discarded as the store fills up.

This method can be applied to many types of centralised networks, but preferably the network is an optical network.

The method of the present invention takes advantage of the behavioural predictability of optical networks controlled by a central entity in order to create a blocking free path setup and teardown method that manages the bandwidth in a highly efficient way.

An example of a method of optimising connection set-up times between nodes in a centrally controlled network will now be described and contrasted with a conventional method with reference to the accompanying drawings in which:—

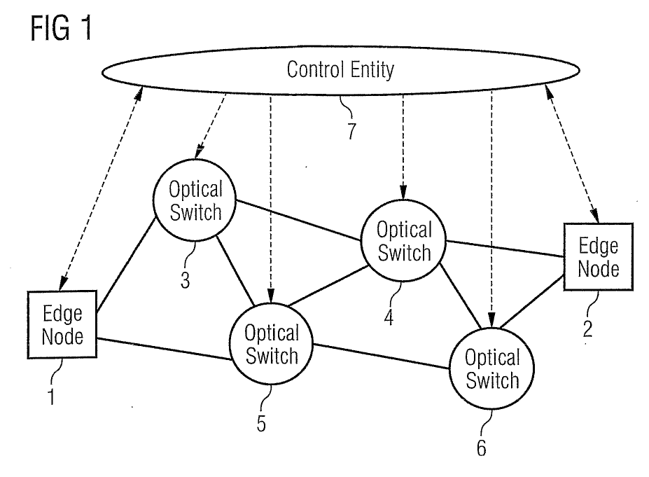

FIG. 1 is a block diagram illustrating a centralised architecture of a type to which the method of the present invention applies;

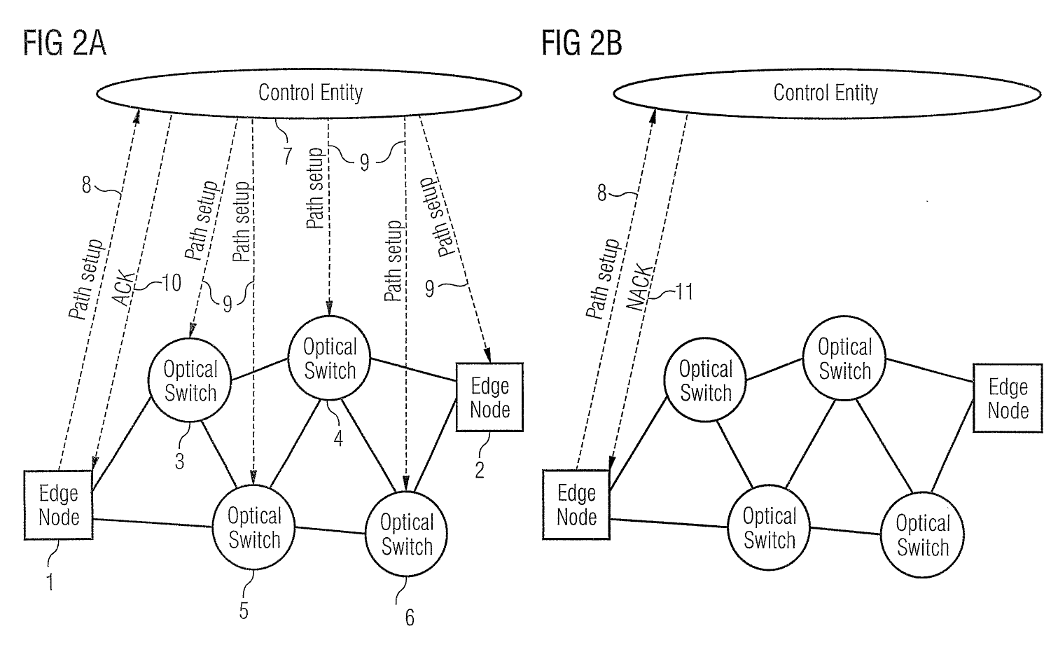

FIG. 2A illustrates signalling paths when a connection is possible in the architecture of FIG. 1;

FIG. 2B illustrates conventional signalling paths when a connection is not possible in the architecture of FIG. 1;

The present invention is concerned in particular with optical networks with two way reservation (2WR) schemes. In such schemes, two types of signalling messages are necessary in order to make a connection between two edge nodes, the first is a path setup message to initiate the connection and the second is an acknowledgement (ACK) or no acknowledgment (NACK) message to confirm or deny the availability of resources for the connection.

Conventionally, the signalling for a centralized network of the type illustrated in FIG. 1 is as follows. Edge nodes 1, 2 can be connected via a number of different optical switches 3, 4, 5, 6 all under the control of a central controller 7. A specific path is set up by the controller sending one way messages to the chosen switches. Each edge node 1, 2 is able to both send and receive messages from the controller 7.

When an edge node 1 wishes to initiate a connection, as shown in FIG. 2A, it must send a path setup message 8 to the controller 7. If there are sufficient resources available in the network to establish the desired connection, the controller 7 sends a path setup message 9 to each node 3, 4, 5, 6, 2 in the end to end path. Finally when the end to end path has been established, the controller sends an ACK message 10 to the edge node 1 that initiated the connection request, indicating that the connection has been established.

However, if there are not enough available resources in the network in order to establish the connection, as shown in FIG. 2B, a NACK message 11 is sent back to the edge node 1, which will have to try to establish a connection at a later time. A problem with this arrangement is that in order to establish the connection, the edge node 1 will have to send a path setup message 8, at least once more and in fact as often as it takes to make the connection. This consumes signalling resources unnecessarily. In addition, since the edge node does not know exactly when the network resources will be available, the connection process is transformed into one of trial and error.

One solution would be to modify the NACK message and to add a timing field with information regarding when the resources will be free in the network. But this implies increasing the intelligence of the edge nodes (by adding a timer and a more complex signal processing unit), which goes against the very principles of a centralized signalling architecture.

The present invention addresses this problem of unnecessary use of signalling resources without increasing the node complexity by only sending the ACK message to the source edge node when there are sufficient resources available in the network to establish an end to end connection, but not sending any NACK message if there are not sufficient resources. With this simple modification, only two signalling messages between edge node and control entity are necessary in order to establish a connection, irrespective of whether there are sufficient resources available in the network initially. In the conventional method, the number of signalling messages where the resources are initially insufficient is not limited.

Using the method of the present invention means that whilst the edge node waits for the ACK message from the control entity, its aggregation buffer fills up with incoming IP packets and if the edge node has to wait too long for the ACK message, its buffer can overflow. This means that some IP packets will have to be discarded. Different queuing systems can be implemented to deal with this scenario. If a first in first out (FIFO) queue is implemented, the last IP packets arriving at the edge node will be discarded. An alternative, which may be preferred for an optical network is a last in first out (LIFO) queue, on the basis that more recent information has greater importance than older information. A preferred scheme is one in which QoS can be taken into account in the network, for instance by using a WFQ (weighted fair queuing) system in the aggregation buffer. This leads to IP packets with a lower priority being discarded first, whenever the aggregation buffer is full.

Amongst the advantages of the path setup and teardown method according to the invention are that it reduces the amount of signalling information, since only two signalling messages between edge node and control entity are necessary in order to establish a connection, irrespective of the resources available in the network; the method is compliant with the centralized philosophy, i.e. it keeps the complexity out of the edge nodes and optical switches and it reduces the blocking probability. When the aggregation buffer in the edge node overflows the information gets lost with the granularity of an IP packet, whereas conventionally the granularity was of a burst (in average around 500 times larger than an IP packet). In addition, it allows implementation of QoS queuing mechanisms very easily, such as WFQ, so that if the buffer in the edge node overflows, IP packets with a lower priority can be selectively dismissed leaving only high priority IP packets in the buffer; and no hardware modification is required.

1.-5. (canceled)

6. A method of optimising connection set-up times between nodes in a centrally controlled network, comprising:
sending a path set-up request from a node to a controller; and
sending an acknowledgment message from the controller to the node, only when a network connection has been established.

7. The method according to claim 6, further comprises providing a queuing system at the node, the queuing system designed such that packets received at the node while awaiting for the acknowledgment are discarded.

8. The method according to claim 7, wherein the packets are based on an Internet protocol.

9. The method according to claim 7, wherein the queuing system has a scheme selected from the group consisting of: first in first out (FIFO), last in first out (LIFO), and weighted fair queuing (WFQ).

10. The method according to claim 9, wherein the WFQ scheme selectively dismisses packets having a lower priority in order to store more recently arrived IP packets having a higher priority.

11. The method according to claim 10, wherein the packets are based on an Internet protocol.

12. The method according to claim 6, wherein the network is an optical network.

13. A method of optimising connection set-up times between nodes in a centrally controlled network, comprising:
receiving a path set-up request by a controller from a node; and
sending an acknowledgment to the node when the connection has been established once resources are available,
whereby the controller no longer sends a negative acknowledgment to the node since the controller waits for the resources to be available.

14. A method of optimising connection set-up times between nodes in a centrally controlled network, comprising:
sending a path set-up request from a node to a controller; and
receiving an acknowledgment message from the controller by the node after a network connection has been established,
wherein a single path set-up request is used to establish a connection even when resources are initially unavailable,
whereby multiple path setup request are no longer needed since the controller does not send a negative acknowledgment but waits for resource availability.

15. The method according to claim 14, further comprises providing a queuing system at the node, the queuing system designed such that packets received at the node while awaiting for the acknowledgment are discarded.

16. The method according to claim 15, wherein the packets are based on an Internet protocol.

17. The method according to claim 15, wherein the queuing system has a scheme selected from the group consisting of: first in first out (FIFO), last in first out (LIFO), and weighted fair queuing (WFQ).

18. The method according to claim 17, wherein the WFQ scheme selectively dismisses packets having a lower priority in order to store more recently arrived IP packets having a higher priority.

19. The method according to claim 18, wherein the packets are based on an Internet protocol.

20. The method according to claim 15, wherein the network is an optical network.
